(19) United States
(12) Patent Application Publication
(10) Pub. No.: US 2026/0186906 A1
(43) Pub. Date: Jul. 2, 2026

(54) METHOD FOR OPERATING SERVER CONTROLLER, SERVER CONTROLLER AND STORAGE SERVER

(71) Applicant: Samsung Electronics Co., Ltd., Suwon-si (KR)

(72) Inventors: Seung Yeon SHIN, Suwon-si (KR); Sang Hyeok PARK, Suwon-si (KR); Yang Woo ROH, Suwon-si (KR); Jin-Hee MA, Suwon-si (KR); Yun Ho YANG, Suwon-si (KR)

(21) Appl. No.: 19/304,965

(22) Filed: Aug. 20, 2025

(30) Foreign Application Priority Data
Jan. 2, 2025 (KR) 10-2025-0000344

(51) Int. Cl. G06F 11/10; G06F 3/06

(52) U.S. Cl. CPC G06F 11/1096; G06F 3/0614; G06F 3/0635; G06F 3/0689

(57) ABSTRACT

A method for operating a server controller that controls a storage server, server controller and storage server are provided. The method comprises a first volume as a first area determined based on a storage capacity of a first storage device having the smallest storage capacity among the plurality of storage devices, generating a second volume as a second area that does not belong to the first area in the plurality of storage devices, and storing first data in the second volume in response to a write command for the first data, a plurality of stripe units constituting the first data being distributed and stored in the plurality of storage devices.

### CROSS-REFERENCE TO RELATED APPLICATION

This application claims priority to Korean Patent Application No. 10-2025-0000344 filed on Jan. 2, 2025, in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method for operating a server controller, a server controller, and a storage server.

### 2. Description of the Related Art

Semiconductor memories include volatile memory devices that lose stored data when power is cut off, such as static random access memory (SRAM) and dynamic random access memory (DRAM), and non-volatile memory devices that retain stored data even when power is cut off, such as flash memory devices, phase-change RAM (PRAM), magneto-resistive RAM (MRAM), resistive RAM (RRAM), and ferroelectric RAM (FRAM).

A storage device is a device that stores data under the control of a host device such as a computer, a smartphone, or a smart pad. The storage device includes a device that stores data on a magnetic disk, such as hard disk drive (HDD), and a device that stores data on a non-volatile memory, such as solid state drive (SSD) and memory card.

In this case, a storage server may include a plurality of storage devices for securing high IO performance and data reliability. Redundant Array of Independent Disks (RAID) may generally be applied to the storage server that includes the plurality of storage devices. The storage server to which the RAID is applied divides data into a plurality of stripes and distributes, and records the divided stripes in the plurality of storage devices.

In some cases, the storage server may also include a plurality of storage devices having different storage capacities. However, when RAID is applied to the storage server that includes the storage devices having different storage capacities, the performance and storage capacity of the storage server may be determined based on the storage device with the lowest storage capacity. This may result in some extra storage space of the storage devices remaining unused.

### SUMMARY

Aspects of the present disclosure provide a method for operating a server controller that controls a storage server.

Aspects of the present disclosure also provide a server controller that controls a storage server.

Aspects of the present disclosure also provide a storage server to which a server controller is applied.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some embodiments of present disclosure, there is provided a method for operating a server controller that controls a storage server including a plurality of storage devices. The method comprises configuring a first volume as a first area of the plurality of storage devices based on a storage capacity of a storage device having the smallest storage capacity among the plurality of storage devices, configuring a second volume as a second area of the plurality of storage devices except the storage device having the smallest storage capacity, the second area being separated from the first area, storing first data in the second volume in response to a write command for writing the first data, and distributing the first data into a plurality of stripe units, and storing the plurality of stripe units in the plurality of storage devices.

According to some embodiments of present disclosure, there is provided a server controller that controls a storage server including a server memory configured to store instructions, and a server processor configured to execute the instructions to configure a first volume as a first area of the plurality of the storage devices based on a storage capacity of a storage device having the smallest capacity among the plurality of the storage devices, configure a second volume as a second area of the plurality of the storage devices except the storage device having the smallest capacity, the second area being separated from the first area in the plurality of storage devices, and store first data in the second volume in response to a write command for writing the first data, and distributing the first data into a plurality of stripe units and storing the plurality of the stripe units in the plurality of storage devices except the storage device having the smallest capacity.

According to some embodiments of present disclosure, there is provided a storage server comprises a first storage device, second and third storage devices having a larger storage capacity than the first storage device, and a server controller controlling the first to third storage devices, wherein the server controller is configured to configure a first volume as a first area of the first to third storage devices based on a storage capacity of the first storage device, configure a second volume as a second area of the second and third storage devices, the second area being separate from the first area in the second and third storage devices, store first data in the second volume in response to a write command for writing the first data, and distributing the first data into a plurality of stripe units and storing the plurality of the stripe units in the second and third storage devices.

The details of other embodiments are included in the detailed description and drawings.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram for describing a server system.

FIG. 2 is a block diagram for describing a host-storage system including a storage device.

FIG. 3 is a diagram for describing a plurality of storage devices having different storage capacities.

FIG. 4 is a block diagram for describing a server controller according to some embodiments.

FIG. 5 is a flowchart for describing an operation of the server controller according to some embodiments.

FIG. 6 is a diagram for describing a mapping table of a storage device.

FIG. 7 is a flowchart for describing an operation of generating a second volume according to some embodiments.

FIGS. 8 and 9 are diagrams for describing the operation of generating the second volume according to some embodiments.

FIG. 10 is a diagram for describing an operation of the server controller according to some embodiments.

FIG. 11 is a flowchart for describing an operation of the server controller according to some embodiments.

FIG. 12 is a flowchart for describing an operation of the server controller according to some embodiments.

FIG. 13 is a diagram for describing an operation of replacing a bad block according to some embodiments.

FIG. 14 is a flowchart for describing an operation of the server controller according to some embodiments.

FIG. 15 is a diagram for describing an operation for replacing a storage device in which a failure has occurred according to some embodiments.

FIG. 16 is a block diagram for describing a server system.

### DETAILED DESCRIPTION OF THE EMBODIMENTS

Hereinafter, embodiments of the present disclosure will be described with reference to the accompanying drawings.

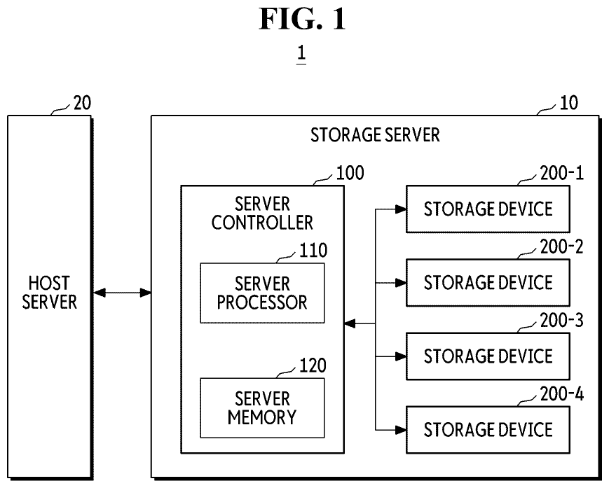

FIG. 1 is a block diagram for describing a server system.

Referring to FIG. 1, a server system 1 may include a host server 20 and a storage server 10. The host server 20 may exchange data with the storage server 10. The host server 20 may transmit a command to the storage server 10 to read data from storage devices 200_1 to 200_4. The storage server 10 may provide requested data to the host server 20 in response to the command. For example, the storage server 10 may read a plurality of stripe units constituting the data requested from the plurality of storage devices 200_1 to 200_4 and provide the requested data to the host server 20. The “stripe unit” may be a unit of data often used in RAID configurations that is distributed across multiple storage devices or memory units to improve performance and/or reliability. The data of a stripe may be split into a plurality of stripe units (or chunks of data) and each stripe unit may be written to a corresponding RAID disk (e.g., a corresponding one of storage devices 200_1 to 200_4). The stripe units of a strip may be written/read in parallel to/from the RAID disks (e.g., storage devices 200_1 to 200_4.

The host server 20 may be implemented to include one or more processor cores. The host server 20 may include a general-purpose processor and a dedicated processor. The host server 20 may be the processor itself, or an electronic device or system including the processor(s).

The storage server 10 may include a server controller 100 and a plurality of storage devices 200_1 to 200_4. Each of the plurality of storage devices 200_1 to 200_4 may store write data or output read data requested by the host server 20. Each of the storage devices 200_1 to 200_4 may be configured as a RAID disk. Although four storage devices 200_1 to 200_4 are illustrated in FIG. 1, the number of storage devices may be more or less than four depending on the embodiment of the disclosure.

For example, each of the storage devices 200_1 to 200_4 may be implemented with at least one storage medium configured to store data permanently or semi-permanently, such as a flash memory device, a Secure Digital (SD) card, a solid state drive (SSD), a hard disk drive (HDD), an optical media such as a magnetic drum, a compact disc (CD), a digital versatile disc (DVD), or a laser disc, a magnetic tape, a magneto-optical disk, and/or a floppy disk.

The server controller 100 may include a server processor 110 and a server memory 120. The server controller 100 may control general operation of the storage server 10. The server controller 100 may be implemented as hardware, software, or a combination of hardware and software to perform various operations of the storage server 10. For example, the server controller 100 may include dedicated circuitry configured to perform a specific operation. Additionally, the server controller 100 may include a server processor 110. The server processor 110 may be a hardware circuit and may be configured by software. The server processor 110 may be one or more general-purpose processors or other hardware processor (e.g., one or more CPUs) configured to execute a set of instructions of a program for performing a specific operation. Various operations of the server controller 100 will be described in detail later.

The server memory 120 may store data associated with the operations of the server controller 100. For storing the data, the server memory 120 may include at least one of non-volatile memories or volatile memories.

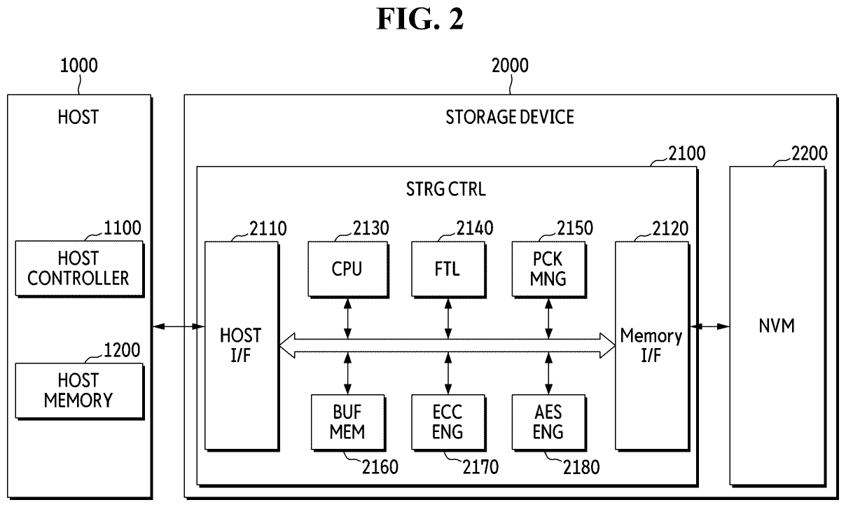

FIG. 2 is a block diagram for describing a host-storage system including a storage device.

Referring to FIG. 2, a host-storage system may include a host 1000 and a storage device 2000. Here, the host 1000 may correspond to the server controller 100 of FIG. 1. A host controller 1100 may correspond to the server processor 110, and a host memory 1200 may correspond to the server memory 120. The storage device 2000 may correspond to one of the storage devices 200_1 to 200_4 of FIG. 1. In FIG. 2, for convenience of explanation, it is assumed that the storage devices 200_1 to 200_4 of FIG. 1 include NAND flash memory.

The storage device 2000 may include a storage controller 2100 and a non-volatile memory device (NVM) 2200. In addition, the host 1000 may include a host controller 1100 and a host memory 1200. The host memory 1200 may function as a buffer memory for temporarily storing data to be transmitted to the storage device 2000 or data transmitted from the storage device 2000.

The storage device 2000 may include storage media for storing data according to a request from the host 1000. As an example, the storage device 2000 may include at least one of a solid state drive (SSD), an embedded memory, or a removable external memory. When the storage device 2000 is the SSD, the storage device 2000 may comply with the non-volatile memory express (NVMe) standard. When the storage device 2000 is the embedded memory or the external memory, the storage device 2000 may comply with the universal flash storage (UFS) standard or the embedded multi-media card (eMMC) standard. The host 1000 and the storage device 2000 may each generate and exchange packets according to the adopted standard protocol.

When the non-volatile memory device 2200 of the storage device 2000 includes a flash memory, the flash memory may include a two-dimensional (2D) NAND memory array or a three dimensional (3D) NAND memory array (e.g., vertical NAND (VNAND) memory array). As another example, the storage device 2000 may include various other types of non-volatile memories. For example, the storage device 2000 may include a magneto-resistive random access memory (MRAM), a spin-transfer torque MRAM (STT-MRAM), a conductive bridging RAM (CBRAM), a ferroelectric RAM (FeRAM), a phase-change RAM (PRAM), a resistive RAM, and various other types of memories.

The host controller 1100 and the host memory 1200 may be implemented as separate semiconductor chips. Alternatively, the host controller 1100 and the host memory 1200 may be integrated in the same semiconductor chip. As an example, the host controller 1100 may be any one of a plurality of modules included in an application processor, and the application processor may be implemented as a system on chip (SoC). In addition, the host memory 1200 may be an embedded memory provided in the application processor or be a non-volatile memory or a memory module disposed outside the application processor.

The host controller 1100 may manage a write operation for writing data (e.g., write data) stored in the host memory 1200 into the non-volatile memory device 2200, or a read operation for reading data (e.g., read data) from the non-volatile memory device 2200 and storing the read data in the host memory 1200.

The storage controller 2100 may include a host interface 2110, a storage-memory interface 2120, and a central processing unit (CPU) 2130 (a processor). In addition, the storage controller 2100 may further include a flash translation layer (FTL) 2140, a packet manager 2150, a buffer memory 2160, an error correction code (ECC) engine 2170, and an advanced encryption standard (AES) engine 2180. The storage controller 2100 may further include a working memory in which the flash translation layer (FTL) 2140 is loaded and executed or otherwise processed. The CPU 2130 may control the write and read operations of the non-volatile memory device 2200 by executing or processing the flash translation layer (FTL) 2140. The FTL may include one or more data tables (e.g., an address translation table) that may be part of the buffer memory 2160 or a separate memory.

Specifically, the storage device 2000 may receive a storage device driving signal from the host 1000 through the host interface 2110. The CPU 2130 may transmit an initialization command in response to the storage device driving signal. The initialization command may be transmitted to the non-volatile memory device 2200 through the storage-memory interface 2120.

The host interface 2110 may transmit and receive packets to and from the host 1000. A packet transmitted from the host 1000 to the host interface 2110 may include a command, data to be written to the non-volatile memory device 2200, or the like. The packet transmitted from the host interface 2110 to the host 1000 may include a response to the command, data read from the non-volatile memory device 2200, or the like. The storage-memory interface 2120 may transmit the data to be written to the non-volatile memory device 2200 or may receive the data read from the non-volatile memory device 2200. The storage-memory interface 2120 may comply with a standard protocol such as Toggle NAND standard or Open NAND flash interface (ONFI) standard.

The flash translation layer 2140 may perform several functions such as address mapping, wear-leveling, and garbage collection. Address mapping is an operation of converting a logical address received from the host 1000 into a physical address used to access a memory location (uniquely identified by the physical address) of the non-volatile memory device 2200 for write or read operations. Wear-leveling is a technology that reduces or prevents excessive use of specific blocks by providing a more uniform usage of blocks across the non-volatile memory device 2200, and may be implemented through firmware that balances the erase counts of physical blocks. Garbage collection is a technology that secures an additional free block in the non-volatile memory device 2200 by copying valid data of a block to another block and then erasing the block. The functions of the flash translation layer 2140 may be implemented by CPU 2130 or another processor of the storage controller 2100.

The packet manager 2150 may generate a packet according to a protocol of an interface agreed with the host 1000 or may parse a variety of information from a packet received from the host 1000. In addition, the buffer memory 2160 may temporarily store the data to be written to the non-volatile memory device 2200 or the data to be read from the non-volatile memory device 2200.

The buffer memory 2160 may be provided in the storage controller 2100, but may also be disposed outside the storage controller 2100.

The ECC engine 2170 may perform an error detection and correction function for read data read from the non-volatile memory device 2200. More specifically, the ECC engine 2170 may generate parity bits for write data to be written to the non-volatile memory device 2200, and the parity bits generated as described above may be stored in the non-volatile memory device 2200 together with the write data. At the time of reading the data from the non-volatile memory device 2200, the ECC engine 2170 may correct an error of the read data based on the parity bits read from the non-volatile memory device 2200 and the read data, and output the corrected read data in which the error is corrected.

The AES engine 2180 may perform an encryption operation on write data to be written into the non-volatile memory device 2200 using a symmetric-key algorithm, and may perform a decryption operation on read data read from the non-volatile memory device 2200 using the symmetric-key algorithm. The AES engine 2180 may be implemented with a hardware or software in compliance with the AES standard.

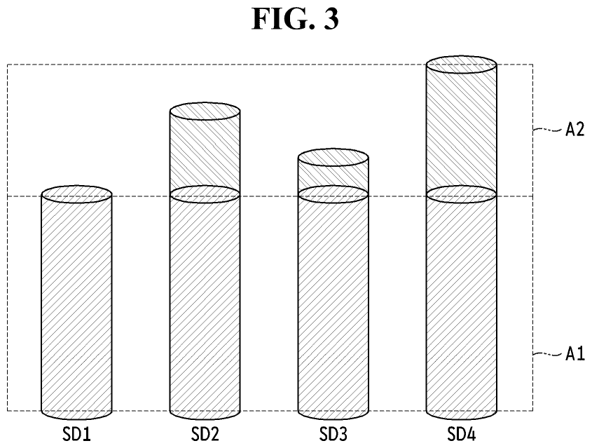

FIG. 3 is a diagram for describing a plurality of storage devices having different storage capacities.

Each of a plurality of storage devices SD1 to SD4 may include a non-volatile memory for storing data and a storage controller for controlling the non-volatile memory. For example, when one of the plurality of storage devices SD1 to SD4 is implemented as a solid state drive (SSD), the non-volatile memory may correspond to the non-volatile memory device 2200 of FIG. 2, and the storage controller may correspond to the storage controller 2100 of FIG. 2. The storage capacities of the non-volatile memories of the plurality of storage devices SD1 to SD4 may be the same, but may also be different.

For example, initially, storage devices configured to have the same capacities may be used for the plurality of storage devices SD1 to SD4, but during the maintenance process, some of the plurality of storage devices SD1 to SD4 may be replaced with other storage devices having different storage capacities. Alternatively, when configuring the storage server (e.g., the storage server 10), the plurality of storage devices SD1 to SD4 may have different storage capacities from the beginning (when initially configuring the storage server). As an example of such a case, when configuring a storage server using some fall-out storage devices SD1 to SD4 with bad blocks in which the number of bad blocks exceeds a threshold number, the storage devices SD1 to SD4 may have different storage capacities from the beginning.

In FIG. 3, a cylinder refers to a storage space of each of the plurality of storage devices SD1 to SD4. The relative height of the cylinder indicates a relative size of the storage capacity of the corresponding storage device. Although four storage devices are illustrated in FIG. 3, the number of storage devices constituting the storage server is not limited to four, and the storage server may include three storage devices or more than four storage devices. Referring to FIG. 3, the first storage device SD1 among the plurality of storage devices SD1 to SD4 may have the smallest storage capacity. In this example, one storage device has the smallest storage capacity, but several storage devices may have the same storage capacity which may also be the smallest of the plurality of storge devices., In this example, the storage capacity increases from the first storage device SD1 in the following order: the third storage device SD3, the second storage device SD2, and the fourth storage device SD4. In this case, the storage capacity of the first storage device SD1 having the smallest storage capacity among the plurality of storage devices SD1 to SD4 may be a reference capacity of a partition storage space of each of the first to fourth storage devices SD1 to SD4. For example, the storage space of each of the plurality of storage devices SD1 to SD4 may be partitioned into a first area A1. In addition, the storage devices other than those having the smallest storage capacity (in this example, SD2 to SD4) may be partitioned into a second area A2. In this example, the first area A1 corresponds to the sum of each storage space of the first to fourth storage devices SD1 to SD4 corresponding to the reference capacity, and the second area A2 corresponds to sum of each remaining storage space of the second to fourth storage devices SD2 to SD4. It should be appreciated that partitioning a storge device need not require division of the memory into smaller portions (e.g., as done in this example with respect to storage devices SD2 to SD4, but may allow for selecting the entire available memory (e.g., as done with respect to storage device SD1). It should also be appreciated that available memory may refer to memory available for user data and may not include other memory, such as memory provided for metadata (e.g., for non-volatile storage of FTL of the storage device).

In this case, a volume provided by the storage server (e.g., the storage server 10) to the host may be determined based on the storage capacity of the first storage device SD1 having the smallest storage capacity. The volume may be a logical storage unit corresponding to the first area A1 of the storage devices SD1 to SD4 of the storage devices. It is a virtualized storage space that can be managed independently for use in RAID configurations or virtualized storage environments. In RAID configurations, the entity responsible for configuring the volume depends on whether the RAID is managed via software or hardware. When the RAID is managed by software, the host (e.g., operating system) sets up and manages the RAID volume, and when the RAID is managed by hardware RAID, the memory controller) is responsible for configuring and managing the RAID volume.

For example, the storage server (e.g., the storage server 10) may provide the first area A1 as a first volume to the host server, and the host server may recognize a size of the first area A1 as a total storage capacity of the storage server (e.g., the storage server 10). As a result, the storage space belonging to the second area A2 may be left unused by the host.

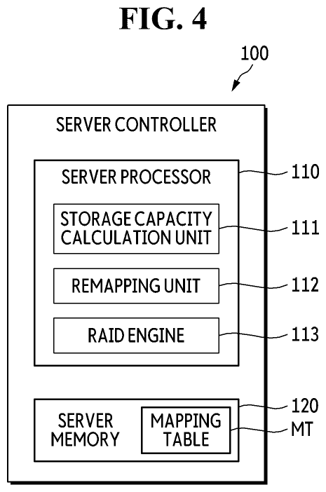

FIG. 4 is a block diagram for describing a server controller according to some embodiments.

Referring to FIG. 4, the server controller 100 may include a server processor 110 and a server memory 120. The server processor 110 may include a storage capacity calculation unit 111, a remapping unit 112, and a RAID engine 113. The storage capacity calculation unit 111, the remapping unit 112, and the RAID engine 113 may be implemented as dedicated hardware or dedicated circuits within the server processor 110, for example. In addition, the server processor 110 may also implement the storage capacity calculation unit 111, the remapping unit 112, and the RAID engine 113 as software by executing firmware stored in the server memory 120, for example, and the storage capacity calculation unit 111, the remapping unit 112, and the RAID engine 113 may be implemented as a combination of dedicated hardware or dedicated circuits and software.

The storage capacity calculation unit 111 may calculate a storage capacity for each of the plurality of storage devices included in the storage server. For example, the server controller 100 may provide a command to request a storage capacity to each of the plurality of storage devices, and the server controller 100 may receive information about the storage capacity from each of the plurality of storage devices and provide the information to the storage capacity calculation unit 111. The storage capacity of a storage device may be the memory size of the storage device that is able to store user data which may be referred to as user data capacity. However, the server controller 100 is not limited thereto, and may, for example, store the information about the storage capacity of each of the plurality of storage devices in the server memory 120. The storage capacity calculation unit 111 may calculate the storage capacity of each of the plurality of storage devices based on the information about the storage capacity.

The remapping unit 112 may generate a mapping table that represents a mapping between a logical address received from the host server and physical addresses of the plurality of storage devices. For example, the server controller 100 may provide an unmap command to each of the plurality of storage devices to remove the mapping between a logical address and a physical address for a specific area (e.g., the second area A2 in FIG. 3). Thereafter, the remapping unit 112 may generate a mapping table MT that represents a mapping between the logical address and the physical address for the specific area (e.g., the second area A2 in FIG. 3) and store the mapping table MT in the server memory 120. The method of generating a mapping table MT will be described in detail later.

The RAID engine 113 may distribute data across the plurality of storage devices and store the distributed data in a plurality of stripe units of the plurality of storage devices by using a RAID method. The RAID method, which is commonly used in RAID configurations, may improve performance of the storage server 10. The RAID engine 113 may generate parity bits by performing a parity calculation based on the plurality of stripe units. The generated parities may be stored on at least some of the plurality of storage devices. Here, the RAID may have different levels, each designed for different purposes such as performance, redundancy, or a balance of both. For example, the RAID may have one of RAID level 0 (Striped SET without parity or Striping), RAID level 1 (Mirrored SET without parity or Mirroring), RAID level 2 (Hamming code parity), RAID level 3 (Striped SET with dedicated parity, bit interleaved parity, or byte level parity), RAID level 4 (Block level parity), RAID level 5 (Striped SET with distributed parity or interleave parity), RAID level 6 (Striped SET with dual distributed parity), RAID level 7, RAID level 10, and RAID level 53, or a hybrid RAID level (e.g., RAID 0+1, RAID 1+0, RAID 5+0, RAID 5+1, or RAID 0+1+5) obtained by merging at least two of the above-mentioned RAID levels.

The server memory 120 may store various data used for the operation of the server controller 100. The server memory 120 may store, for example, the mapping table MT generated by the remapping unit 112.

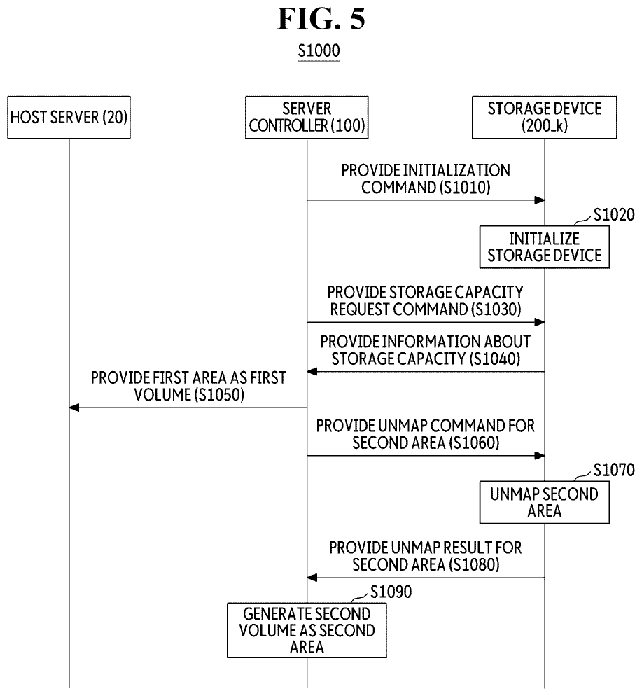

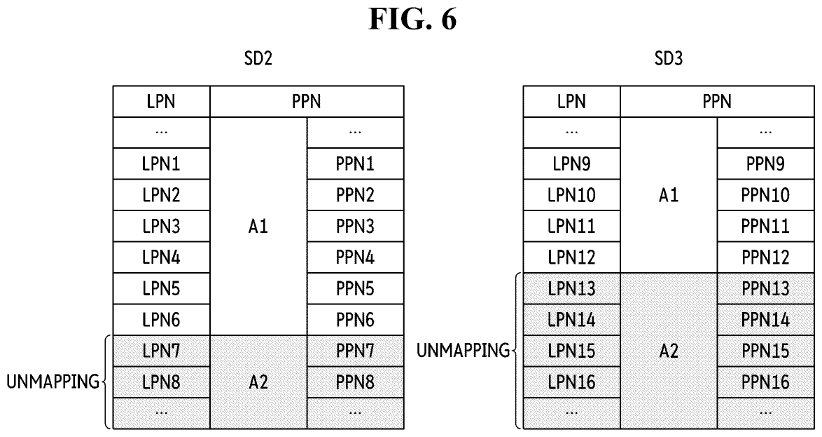

FIG. 5 is a flowchart for describing an operation of the server controller according to some embodiments. FIG. 6 is a diagram for describing a mapping table of a storage device.

In FIG. 5, a storage device 200_k may be one of the plurality of storage devices 200_1 to 200_4 of FIG. 1. Each operation of the server controller described in FIG. 5 may be performed either by dedicated hardware or dedicated circuitry configured to perform such an operation, or by a processor (e.g., the server processor 110 in FIG. 1) executing a program (e.g., firmware) stored in a memory (e.g., the server memory 120 in FIG. 1). The program may comprise a plurality of instructions that cause/direct the processor to perform each operation. Referring to FIG. 5, a method (S1000) for operating a server controller may include the server controller 100 providing an initialization command to the plurality of storage devices including the storage device 200_k (S1010). For example, the server controller 100 may provide an initialization command to the plurality of storage devices including the storage device 200_k. The initialization command may include, for example, a command to delete all data stored in the plurality of storage devices including the storage device 200_k.

The plurality of storage devices including the storage device 200_k may perform initialization in response to the initialization command of the server controller 100 (S1020). For example, the plurality of storage devices including the storage device 200_k may delete all data stored in the plurality of storage devices including the storage device 200_k according to the initialization command from the server controller 100.

The method (S1000) for operating the server controller may include the server controller 100 providing a command requesting storage capacity information to the plurality of storage devices including the storage device 200_k (S1030). However, when the storage capacity information of the plurality of storage devices including the storage device 200_k is already stored in the server controller 100, operation S1030 may be omitted.

The plurality of storage devices including storage device 200_k may provide the storage capacity information to the server controller 100 in response to the storage capacity request command from the server controller 100 (S1040). However, when the operation (S1030) is omitted because the storage capacity information of the plurality of storage devices including the storage device 200_k is already stored in the server controller 100, the operation (S1040) may also be omitted.

The method (S1000) for operating the server controller may include the server controller 100 providing a first area as a first volume to the host server 20 (S1050). The first area may be, for example, the first area A1 described in FIG. 3. The server controller 100 may configure RAID for the first area and provide the first area as the first volume to the host server 20. The server controller 100 may provide the first area as a single volume, or may provide the first area as two or more volumes to the host server 20 by dividing the first area into two or more volumes. The host server 20 may recognize a size of the first area as a total storage capacity of the server controller 100. Thereafter, the server controller 100 may receive data to be written from the host server 20, and distribute the data to be written into a plurality of stripe units and store the distributed stripe units in the first area of the plurality of storage devices.

The method (S1000) for operating the server controller may include the server controller 100 providing an unmap command for a second area to the plurality of storage devices including the storage device 200_k (S1060). The second area may be, for example, the second area A2 described in FIG. 3. For example, the server controller 100 may provide the uncap command for the second area to other storage devices except for the storage device having the smallest storage capacity among the plurality of storage devices. Assuming that the storage server includes a first storage device, a second storage device, and a third storage device, and that the storage device having the smallest storage capacity is the first storage device, the server controller 100 may provide the unmap command for the second area to the second and third storage devices. The unmap command may correspond to a vendor specific command. If the storage device 200_k is a device (e.g., a hard disk drive (HDD)) that does not require translation between logical and physical addresses, the operation (S1060) and subsequent operations (S1070 and S1080) may be omitted.

The plurality of storage devices including the storage device 200_k may perform an unmap operation for the second area in response to the unmap command of the server controller 100 for the second area (S1070). For example, assuming that the storage server includes a first storage device, a second storage device, and a third storage device, and that the storage device having the smallest storage capacity is the first storage device, the storage controllers of the second and third storage devices may perform the unmap operation for the second area in response to the unmap command for the second area.

Referring to FIG. 6, the storage controllers of the second and third storage devices SD2 and SD3 may remove (i.e., unmap) the mapping between logical page number (LPN) and physical page number (PPN) included in the second area A2 in response to the command from the server controller 100.

The plurality of storage devices including the storage device 200_k may provide an unmap result for the second area in response to the unmap command of the server controller 100 (S1080). However, in some embodiments, the operation (S1080) may be omitted.

The method (S1000) for operating the server controller may include the server controller 100 generating a second volume as the second area (S1090). A detailed method for generating the second volume will be described later.

According to some embodiments, the server controller 100 may utilize the generated second volume in various ways. For example, the server controller 100 may utilize the second volume as a data buffer for temporarily storing user data or metadata for performing a specific operation, etc. In this case, the server controller 100 may configure RAID for the second volume, and may regard the second volume as a separate RAID configuration. Accordingly, the server controller 100 may distribute write data into a plurality of stripe units and store the distributed stripe units in the plurality of storage devices in the second volume. Because the server controller regards the second volume as an additional RAID configuration, the write data may be distributed across the storage devices in the second volume and may be processed in parallel. Accordingly, overall data I/O performance of a storage server may be improved.

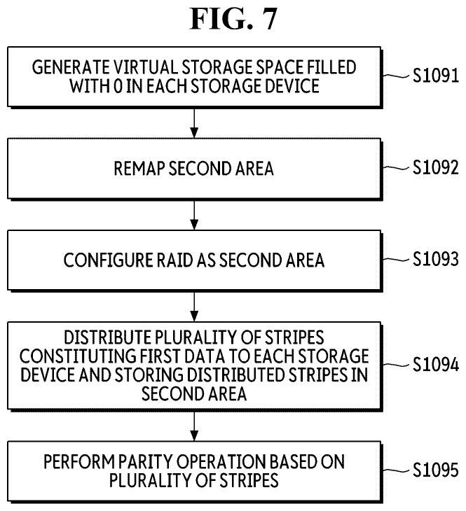

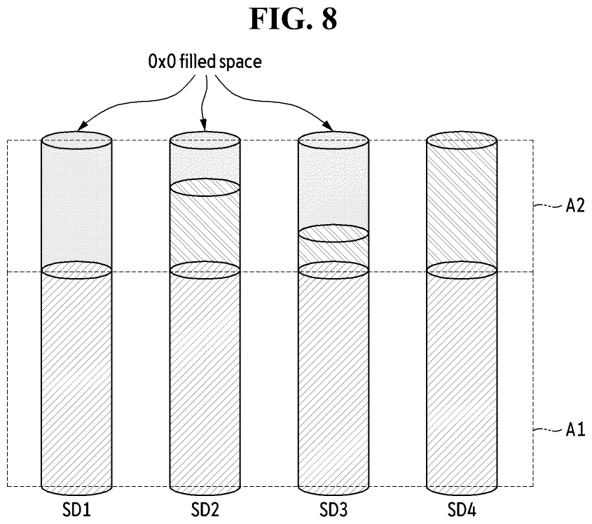

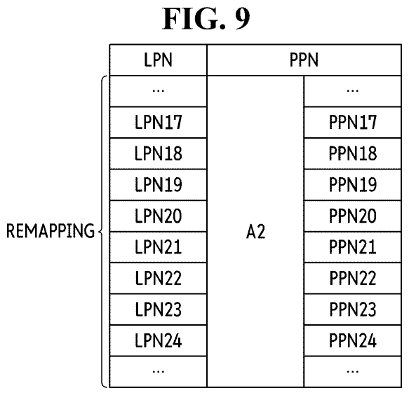

FIG. 7 is a flowchart for describing an operation of generating a second volume according to some embodiments. FIGS. 8 and 9 are diagrams for describing the operation of generating the second volume according to some embodiments.

The operation (S1090) of FIG. 5 is described in detail with reference to FIG. 7. The method (S1000) for operating the server controller may include the server controller 100 generating a virtual storage space filled with ‘0’ (or ‘0×0’) in the plurality of storge devices including the storage device 200_k (S1091). Referring also to FIG. 8, the server controller 100 may set a preset storage capacity for the storage devices based on the maximum storage capacity among storage capacities of the storage devices. The server controller 100 may generate a virtual storage space corresponding to a difference between storage capacity of each storage device and the preset storage capacity for a storage device having a storage capacity smaller than the preset storage capacity and fill the virtual storage space with ‘0’. Since the virtual storage space filled with ‘0’ is a storage space that does not actually exist, data may not be written to such a virtual storage space. Alternatively, depending on the embodiment of the disclosure, a virtual storage space may be filled with ‘1’ instead of ‘0’, or may be recorded with a specific value. The virtual storage space, combined with the second area, may form the second volume. The data filled in the virtual storage space may be used generating parity bits for a RAID configuration.

The description is made with reference to FIG. 8 together. In FIG. 8, a detailed description of the contents overlapping FIG. 3 will be omitted. Assume that the storage server includes first to fourth storage devices SD1 to SD4. The server controller 100 may generate a virtual storage space filled with ‘0’ for each of the first to third storage device SD1 to SD3 which has a storage capacity that is smaller than the storage capacity of the fourth storage device SD4, when the storage capacity of the fourth storage device SD4 has the largest storage capacity among the first to fourth storage devices SD1 to SD4, for example.

The method (S1000) for operating the server controller may include the server controller 100 performing remapping with respect to the second area (S1092). As some of the plurality of storage devices have performed the unmap operation for the second area in response to the unmap command for the second area, the server controller 100 may perform a remapping operation for the second area unmapped in each storage device.

The description is made with reference to FIG. 9 together. The second area A2 may be the same as the second area A2 of FIG. 6. The server controller 100 may perform the remapping operation between the logical address and the physical address for the second area A2.

While the server controller 100 performing the remapping operation for the second area unmapped in each storage device, the server controller 100 may not perform translation between the logical address and the physical address for data to be stored in the storage device through a specific configuration (e.g., a flash translation layer when the storage device is a solid state drive (SSD)) within the storage device, but may directly perform translation between the logical address and the physical address.

The method (S1000) for operating the server controller may include the server controller 100 configuring RAID for the second area (S1093). When the server controller 100 configures the RAID for the second area, the RAID may be configured to include the virtual storage space filled with ‘0’ generated in the operation (S1091). As a result, the server controller 100 may configure the RAID to include the storage devices that have a storage capacity smaller than the preset storage capacity.

The method (S1000) for operating the server controller may include distributing a plurality of stripe units constituting the received data to each storage device and storing the distributed stripe units in the second area (S1094). When the server controller 100 configures the RAID for the second area, the server controller 100 may distribute the plurality of stripe units that constitute the received data to store the data received from the host server in the second area and store the distributed stripe units in the plurality of storage devices.

The method (S1000) for operating the server controller may include performing a parity calculation based on the plurality of stripe units constituting the received data (S1095). When the server controller 100 configures the RAID for the second area, the parity operation needs to be performed according to a level of the configured RAID. The server controller 100 may calculate parities based on the plurality of stripe units corresponding to the data received from the host server and store the generated parity bits in the plurality of storage devices.

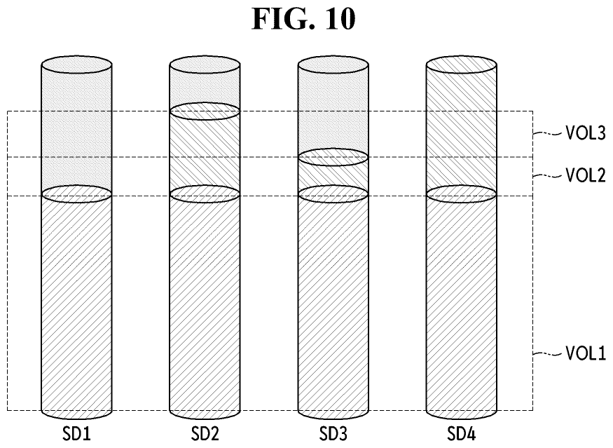

FIG. 10 is a diagram for describing an operation of the server controller according to some embodiments.

In FIG. 10, a detailed description of the contents described with reference to FIG. 3 will be omitted. Referring to FIG. 10, the server controller 100 may generate two or more volumes as the second area. For example, the server controller 100 may divide the second area into second to third volumes VOL2 to VOL3 and separately configure RAID for each volume.

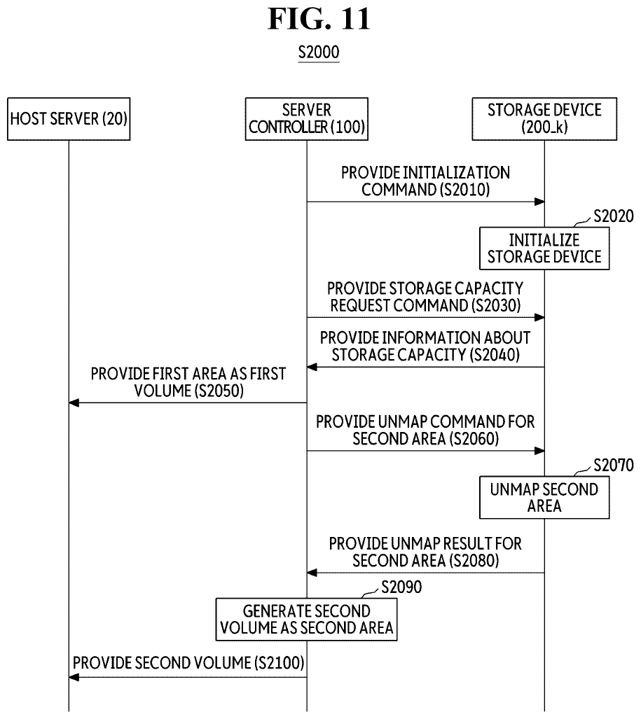

FIG. 11 is a flowchart for describing an operation of the server controller according to some embodiments. In FIG. 11, a detailed description of the content described with reference to FIG. 5 will be omitted. Referring to FIG. 11, a method (S2000) for operating a server controller may include the server controller 100 providing an initialization command to the storage device 200_k (S2010). The storage device 200_k may perform initialization in response to the initialization command (S2020). In addition, the method (S2000) for operating the server controller may include the server controller 100 providing a command to request storage capacity information to the storage device 200_k (S2030), and the storage device 200_k may provide the storage capacity information to the server controller 100 in response to the storage capacity request command from the server controller 100 (S2040).

The method (S2000) for operating the server controller may include the server controller 100 providing a first area as a first volume to the host server 20 (S2050) and providing an unmap command for a second area to the storage device 200_k (S2060). The storage device 200_k may perform an unmap operation for the second area in response to the unmap command (S2070) and provide the unmap result for the second area to the server controller 100 (S2080).

The method (S2000) for operating the server controller may include the server controller 100 generating a second volume as the second area (S2090) and providing the generated second volume to the host server (S2100).

According to some embodiments, the server controller 100 may provide an additional volume generated for the second area to the host server in addition to the volumes generated from the first area. Therefore, even if a storage server is configured with storage devices that are below commercial standard, the storage space of the storage device may be maximized, thereby providing a storage server with reduced costs.

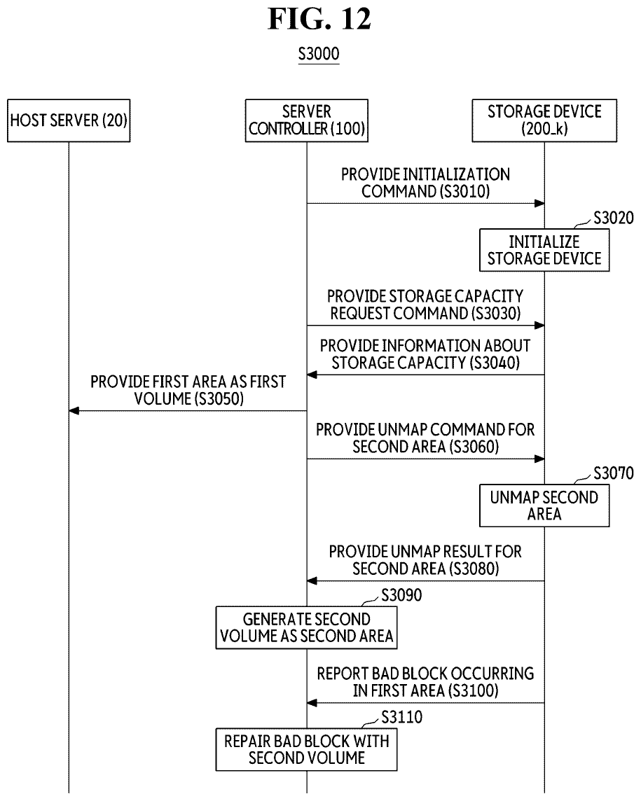

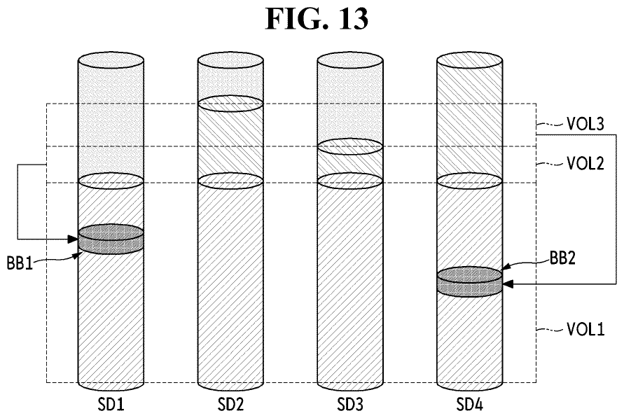

FIG. 12 is a flowchart for describing an operation of the server controller according to some embodiments. FIG. 13 is a diagram for describing an operation of replacing a bad block according to some embodiments.

In FIG. 12, a detailed description of the content described with reference to FIG. 5 will be omitted. Referring to FIG. 12, a method (S3000) for operating a server controller may include the server controller 100 providing an initialization command to the storage device 200_k (S3010). The storage device 200_k may perform initialization in response to the initialization command (S3020). In addition, the method (S3000) for operating the server controller may include the server controller 100 providing a command to request a storage capacity information to the storage device 200_k (S3030), and the storage device 200_k may provide the storage capacity information to the server controller 100 in response to the storage capacity request command of the server controller 100 (S3040).

The method (S3000) for operating the server controller may include the server controller 100 providing a first area as a first volume to the host server 20 (S3050) and providing an unmap command for a second area to the storage device 200_k (S3060). The storage device 200_k may perform an unmap operation for the second area in response to the unmap command (S3070) and provide the unmap result for the second area to the server controller 100 (S3080).

The method (S3000) for operating the server controller may include the server controller 100 generating a second volume as the second area (S3090), and may include performing replacement of a bad block occurring in the first area with the second volume (S3110) in response to the storage device 200_k reporting the bad block occurring in the first area (S3100).

Referring to FIG. 13 together, it is assumed that the first area is provided as a first volume VOL1 to the host server 20, and a bad block has occurred and is identified in the first volume VOL1. Each of the storage devices SD1 to SD4 may detect an error while attempting to write or read data at a location within a block and thus determine that the block is a bad block. If an error is detected during the write or read operation, the storage devices SD1 to SD4 may report the error to the server controller 100, indicating that a bad block has occurred (exists) in the first area. For example, the first storage device SD1 may include a first bad block BB1, and the fourth storage device SD4 may include a second bad block BB2. The server controller 100 may perform replacement of the first bad block BB1 with a block of the second volume VOL2. For example, the server controller 100 may remap the first bad block BB1 to the second volume VOL2 and update the mapping table. Thereafter, data originally intended for the first bad block BB1 may be redistributed to a block previously associated with the second volume VOL2 and stored in a plurality of stripe units of the second volume using a RAID method. The server controller 100 may calculate parities based on the plurality of stripe units, and store the generated parities in the second volume VOL2 of the storage devices. Additionally, the server controller 100 may remap the second bad block BB2 to a third volume VOL3, and data originally intended for the second bad block BB2 may be redistributed to the third volume and stored in a plurality of stripe units of the third volume VOL3 across the storage devices using a RAID method. The server controller 100 may calculate parities based on the plurality of stripe units, and store the generated parities in the third volume VOL3 of the storage devices.

If the replacement is done with unused storage space in another storage device (e.g., storage device B) when replacing a bad block that occurred in a storage device (e.g., storage device A), the data in the bad blocks may be lost when a failure occurs in the replaced storage device (e.g., storage device B).

According to some embodiments, if a bad block in a storage device (e.g., storage device A) is replaced with a volume to which RAID is applied, the data in the bad block may be recovered using parity bits stored in other storage devices. Through this, a storage server with improved reliability may be provided.

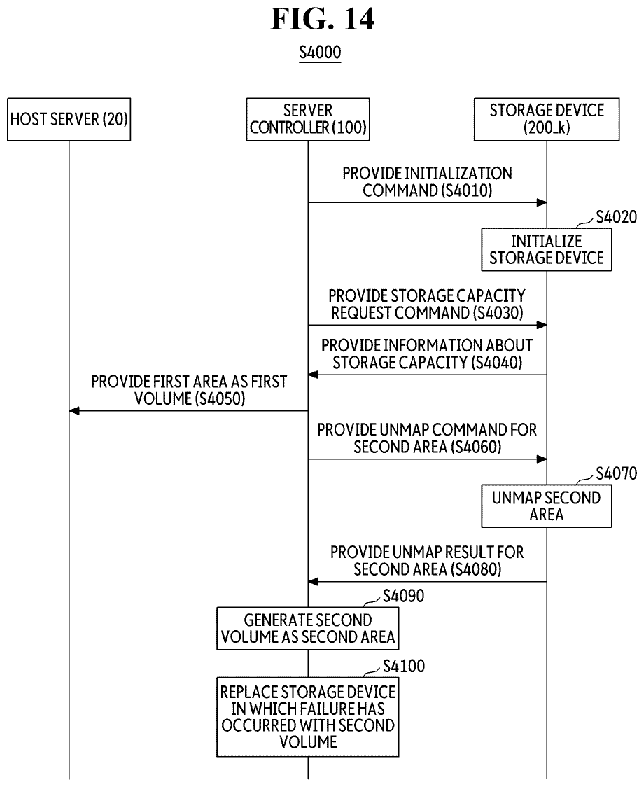

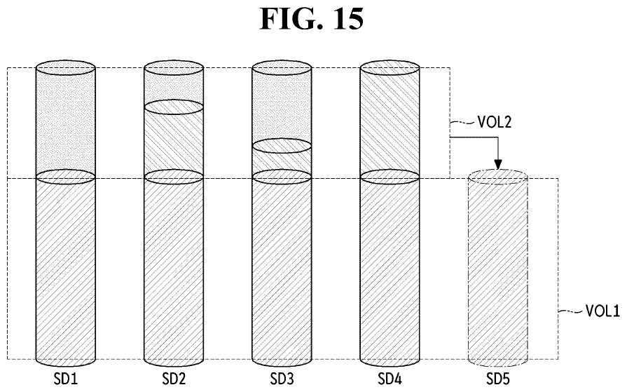

FIG. 14 is a flowchart for describing an operation of the server controller according to some embodiments. FIG. 15 is a diagram for describing an operation for replacing a storage device in which a failure has occurred according to some embodiments.

In FIG. 14, a detailed description of the content described with reference to FIG. 5 will be omitted. Referring to FIG. 12, a method (S4000) for operating a server controller may include the server controller 100 providing an initialization command to the storage device 200_k (S4010). The storage device 200_k may perform initialization in response to the initialization command (S4020). In addition, the method (S4000) for operating the server controller may include the server controller 100 providing a command to request a storage capacity to the storage device 200_k (S4030), and the storage device 200_k may provide information about the storage capacity to the server controller 100 in response to the storage capacity request command of the server controller 100 (S4040).

The method (42000) for operating the server controller may include the server controller 100 providing a first area as a first volume to the host server 20 (S4050) and providing an unmap command for a second area to the storage device 200_k (S4060). The storage device 200_k may perform an unmap operation for the second area in response to the unmap command (S4070) and provide the unmap result for the second area to the server controller 100 (S4080).

The method (S4000) for operating the server controller may include the server controller 100 generating a second volume for the second area (S4090) and replacing a storage device in which a failure has occurred with the second volume (S4100). The “failure” may indicate that a bad block, in which read or write operation may not be performed correctly, has occurred and there are no available reserved blocks for replacing the bad block in the storage device. Referring to FIG. 15 together, a failure may occur in a first storage device SD1 among the plurality of storage devices. The server controller 100 may replace the first storage device SD1 in which the failure has occurred with the generated second volume VOL2 and provide the second volume VOL2 to the host server 20. The host server 20 may recognize the second volume VOL2 as a fifth storage device SD5. The storage device (e.g., the first storage device SD1) in which such a failure has occurred may be called a bad storage device.

According to some embodiments, by replacing the storage device in which the failure has occurred with an unused area of other storage devices, reliability of a storage server may be improved and availability of the storage server may be enhanced.

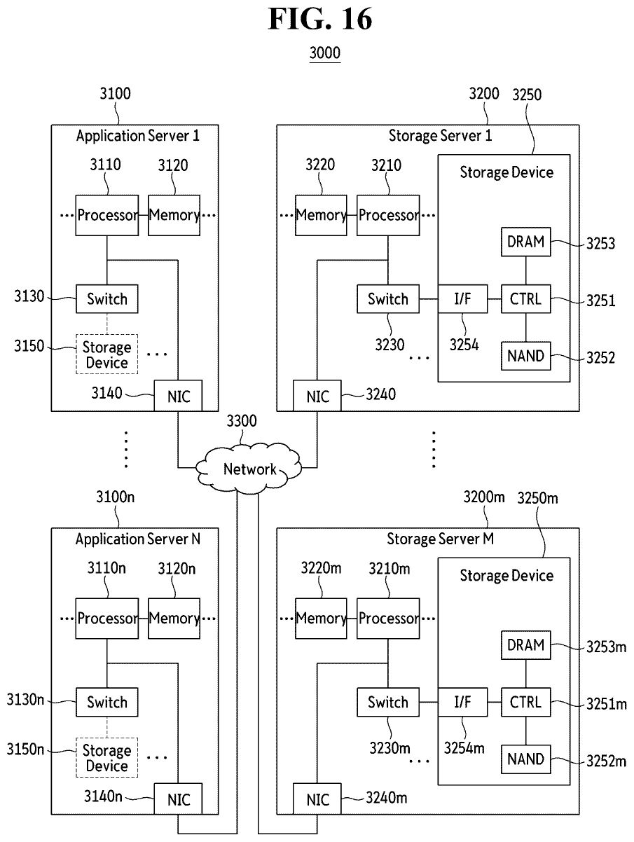

FIG. 16 is a block diagram for describing a server system.

Referring to FIG. 16, a server system 3000 is a system that collects various data and provides services. The server system 3000 may be a system for operating a search engine and a database, and may be a computing system used in a business such as a bank or a government institution. The server system 3000 may include application servers 3100 to 3100n and data storage servers 3200 to 3200m. The number of application servers 3100 to 3100n and the number of data storage servers 3200 to 3200m may be variously selected depending on the embodiment, and may be different from each other.

The application server 3100 or the data storage server 3200 may include at least one of processors 3110 and 3210 and memories 3120 and 3220. The data storage server 3200 is described as an example. The processor 3210 may control an overall operation of the data storage server 3200, and may access the memory 3220 to execute instructions and/or data loaded into the memory 3220. The processor 3210 may be, for example, the host device (20 in FIG. 1) described above. The memory 3220 may be, for example, a persistent memory device (100 in FIG. 1) described above, a double data rate synchronous DRAM (DDR SDRAM), a high bandwidth memory (HBM), a hybrid memory cube (HMC), a dual in-line memory module (DIMM), an Optane DIMM, or a non-volatile DIMM (NVMDIMM). Depending on embodiments, the number of processors 3210 and the number of memories 3220 included in the data storage server 3200 may be variously selected.

The processor 3210 and the memory 3220 may provide a processor-memory pair. In some embodiments, the number of processors 3210 and the number of memories 3220 may be different from each other. The processor 3210 may include a single-core processor or a multi-core processor. The description of the data storage server 3200 may also be similarly applied to the application server 3100. Depending on the embodiments, the application server 3100 may not include a server data storage device 3150. The data storage server 3200 may include one or more server data storage devices 3250. The number of server data storage devices 3250 included in the data storage server 3200 may be variously selected depending on the embodiments.

The application servers 3100 to 3100n and the data storage servers 3200 to 3200m may communicate with each other through a network 3300. The network 3300 may be implemented using a fiber channel (FC) or Ethernet. In this case, the FC may be a medium used for relatively high-speed data transmission, and may use an optical switch providing high performance/high availability. Depending on the access method of the network 3300, the data storage servers 3200 to 3,200m may be provided as file storage, block storage, or object storage.

The network 3300 may be a storage-only network, such as a storage area network (SAN). For example, the SAN may be an FC-SAN that uses an FC network and is implemented according to an FC protocol (FCP). As another example, the SAN may be an IP-SAN that uses a TCP/IP network and is implemented according to an SCSI over TCP/IP or Internet SCSI (iSCSI) protocol. In another embodiment, the network 3300 may be a generic network, such as a TCP/IP network. For example, the network 3300 may be implemented according to protocols such as FC over Ethernet (Foe), Network Attached Storage (NAS), and NVMe over Fabrics (NVMe-oF).

Hereinafter, the application server 3100 and the data storage server 3200 will be mainly described. The description of the application server 3100 may also be applied to another application server 3100n, and the description of the data storage server 3200 may also be applied to another data storage server 3200m.

The application server 3100 may store data requested to be stored by a user or a client in one of the data storage servers 3200 to 3200m through the network 3300. In addition, the application server 3100 may acquire data requested to be read by a user or a client from one of the data storage servers 3200 to 3200m through the network 3300. For example, the application server 3100 may be implemented as a web server or a database management system (DBMS).

The application server 3100 may access a memory 3120n or a server data storage device 3150n included in another application server 3100n through the network 3300, or may access memories 3220 to 3220m or server data storage device 3250 to 3250m included in the data storage servers 3200 to 3200m through the network 3300. Accordingly, the application server 3100 may perform various operations on data stored in the application servers 3100 to 3100n and/or the data storage servers 3200 to 3200m. For example, the application server 3100 may execute an instruction for moving or copying data between the application servers 3100 to 3100n and/or the data storage servers 3200 to 3200m. In this case, the data may be moved to the memories 3120 to 3120n of the application servers 3100 to 3100n through the memories 3220 to 3220m of the data storage servers 3200 to 3200m from the server data storage devices 3250 to 3250m of the data storage servers 3200 to 3200m, or may be directly moved to the memories 3120 to 3120n of the application servers 3100 to 3100n. The data moving through the network 3300 may be encrypted data for security or privacy.

The data storage server 3200 is described as an example. An interface 3254 may provide a physical connection between the processor 3210 and a controller 3251 and a physical connection between a network interconnect (NIC) 3240 and the controller 3251. For example, the interface 3254 may be implemented in a direct attached storage (DAS) method for directly connecting the server data storage device 3250 with a dedicated cable. In addition, for example, the interface 3254 may be implemented in various interface manners such as an advanced technology attachment (ATA), a serial ATA (SATA), an external SATA (e-SATA), a small computer small interface (SCSI), a serial attached SCSI (SAS), a peripheral component interconnection (PCI), a PCI express (PCIe), an NVM express (NVMe), an institute of electrical and electronic engineers (IEEE) 1394, a universal serial bus (USB), a secure digital (SD) card, a multi-media card (MMC), an embedded multi-media card (eMMC), a universal flash storage (UFS), an embedded UFS (elf's), and a compact flash (CF) card interface.

The data storage server 3200 may further include a switch 3230 and a NIC 3240. The switch 3230 may selectively connect the processor 3210 and the server data storage device 3250 or selectively connect the NIC 3240 and the server data storage device 3250 under the control of the processor 3210.

The NIC 3240 may include a network interface card, a network adapter, and the like. The NIC 3240 may be connected to the network 3300 by a wired interface, a wireless interface, a Bluetooth interface, an optical interface, or the like. The NIC 3240 may include an internal memory, a digital signal processor (DSP), a host bus interface, and the like, and may be connected to the processor 3210 and/or the switch 3230 through a host bus interface. The host bus interface may also be implemented as one of the examples of interface 3254 described above. In an embodiment, the NIC 3240 may also be integrated with at least one of the processor 3210, the switch 3230, and the server data storage device 3250.

In the data storage servers 3200 to 3200m or the application servers 3100 to 3100n, the processor may program or read data by transmitting a command to the server data storage devices 3130 to 3130n and 3250 to 3250m or the memories 3120 to 3120n and 3220 to 3220m. In this case, the data may be error-corrected data through an error correction code (ECC) engine. The data is data processed by data bus inversion (DBI) or data masking (DM), and may include cyclic redundancy check (CRC) information. The data may be encrypted data for security or privacy.

The server data storage devices 3150 to 3150m and 3250 to 3250m may transmit a control signal and a command/address signal to NAND flash memory devices 3252 to 3252m in response to a read command received from the processor. Accordingly, when data is read from the NAND flash memory devices 3252 to 3252m, a read enable (RE) signal may be input as a data output control signal and serve to output the data to a DQ bus. A data strobe (DQS) may be generated using the RE signal. The command and address signals may be latched in a page buffer according to a rising edge or a falling edge of a write enable (WE) signal.

The controller 3251 may control an overall operation of the server data storage device 3250. In an embodiment, the controller 3251 may include a static random access memory (SRAM). The controller 3251 may write data to the NAND flash 1252 in response to a write command, or may read data from the NAND flash 1252 in response to a read command. For example, the write command and/or the read command may be provided from the processor 3210 in the data storage server 3200, the processor 3210m in another data storage server 3200m, or the processors 3110 and 3110n in the application servers 3100 and 3100n. A DRAM 3253 may temporarily store (buffer) data to be written to the NAND flash 3252 or data read from the NAND flash 3252. In addition, the DRAM 3253 may store metadata. Here, the metadata is data generated by the controller 3251 to manage the NAND flash 3252 (e.g., the FTL layer). The server data storage device 3250 may include a secure element (SE) for security or privacy.

One of the data storage servers 3200 to 3200m may correspond to the storage server 10 of FIG. 1. One of the application servers 3100 to 3100n may correspond to the host server 20 of FIG. 1. The processor 3210 and the memory 3220 of the data storage server 3200 may correspond to the server processor 110 and the server memory 120 of FIG. 1, respectively.

According to some embodiments, the data storage server 3200 may include at least three server data storage devices including server data storage device 3250. The processor 3210 may generate a first volume as a first area determined based on a storage capacity of a server data storage device having the smallest storage capacity among the plurality of server data storage devices. In addition, the processor 3210 may generate a second volume as a second area that does not belong to the first area in the plurality of server data storage devices. The processor 3210 may store first data in the second volume in response to a write command for the first data of at least one of the application servers 3100 to 3100n, for example, and may distribute and store a plurality of stripe units constituting the first data in the plurality of server data storage devices.

Although some embodiments of the present disclosure have been described above with reference to the accompanying diagrams, the present invention may not be limited to the described embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A method for operating a server controller that controls a storage server including a plurality of storage devices, the method comprising:
configuring a first volume as a first area of the plurality of storage devices based on a storage capacity of a storage device having the smallest storage capacity among the plurality of storage devices;
configuring a second volume as a second area of the plurality of storage devices except the storage device having the smallest storage capacity, the second area being separated from the first area;
storing first data in the second volume in response to a write command for writing the first data; and
distributing the first data into a plurality of stripe units, and storing the plurality of stripe units in the plurality of storage devices.

2. The method of claim 1, further comprising generating parity bits by performing a parity calculation based on the plurality of stripe units in response to the write command for writing the first data, and storing the generated parity bits in the plurality of storage devices.

3. The method of claim 1, wherein the server controller includes a mapping table representing a mapping between a logical address received from a host server and physical addresses of the plurality of storage devices with respect to the second area.

4. The method of claim 3, further comprising providing, to each of the plurality of storage devices, an unmap command to remove a mapping between the logical address received from the host server and the physical addresses of the plurality of storage devices with respect to the second area.

5. The method of claim 1, further comprising replacing a bad block in the first area with a memory block of the second volume.

6. The method of claim 5, wherein the replacing of the bad block in the first area with the memory block the second volume further includes remapping the bad block in the first area to the memory block of the second volume.

7. The method of claim 1, further comprising replacing a first storage device among the plurality of storage devices with memory blocks in the second volume when the first storage device among the plurality of storage devices is determined as a bad storage device.

8. The method of claim 1, further comprising providing a storage capacity request command to the plurality of storage devices and receiving storage capacity information from the plurality of storage devices, in which the storage capacity information indicates storage space for user data used for configuring the first and second volumes.

9. A server controller that controls a storage server including a plurality of storage devices, the server controller comprising:
a server memory configured to store instructions; and
a server processor configured to execute the instructions to:
configure a first volume as a first area of the plurality of the storage devices based on a storage capacity of a storage device having the smallest capacity among the plurality of the storage devices,
configure a second volume as a second area of the plurality of the storage devices except the storage device having the smallest capacity, the second area being separated from the first area in the plurality of storage devices, and
store first data in the second volume in response to a write command for writing the first data, and distributing the first data into a plurality of stripe units and storing the plurality of the stripe units in the plurality of storage devices except the storage device having the smallest capacity.

10. The server controller of claim 9, wherein the server processor is configured perform a parity calculation based on the plurality of stripe units, in response to the write command for the first data.

11. The server controller of claim 9, wherein the server processor is further configured to generate a mapping table representing a mapping between a logical address received from a host server and physical addresses of the plurality of storage devices with respect to the second area.

12. The server controller of claim 11, wherein the server processor is further configured to provide, to each of the plurality of storage devices, an unmap command to remove a mapping between the logical address received from the host server and the physical addresses of the plurality of storage devices with respect to the second area.

13. The server controller of claim 9, wherein the server processor is further configured to replace a bad block in the first area with a memory block of the second volume.

14. The server controller of claim 13, wherein the server processor is further configured to remap the bad block in the first area to the second volume.

15. The server controller of claim 9, wherein the server processor is further configured to replace a bad storage device with the second volume by executing the instructions when a failure has occurred in the bad storage device among the plurality of storage devices.

16. A storage server comprising:
a first storage device;
second and third storage devices having a larger storage capacity than the first storage device; and
a server controller controlling the first to third storage devices,
wherein the server controller is configured to:
configure a first volume as a first area of the first to third storage devices based on a storage capacity of the first storage device,
configure a second volume as a second area of the second and third storage devices, the second area being separate from the first area in the second and third storage devices,
store first data in the second volume in response to a write command for writing the first data, and
distributing the first data into a plurality of stripe units and storing the plurality of the stripe units in the second and third storage devices.

17. The storage server of claim 16, wherein the server controller is configured perform a parity calculation based on the plurality of stripe units in response to the write command for the first data.

18. The storage server of claim 16, wherein the server controller includes a mapping table representing a mapping between a logical address received from a host server and physical addresses of the first to third storage devices with respect to the second area.

19. The storage server of claim 18, wherein the server controller is configured issue an unmap command to each of the first to third storage devices for removing mapping between the logical address received from the host server and physical addresses of the first to third storage devices with respect to the second area.

20. The storage server of claim 16, wherein the server controller is configured replace a bad block in the first area with a memory block of the second volume.
